(19) United States
(12) Patent Application Publication
(10) Pub. No.: US 2015/0264783 A1
(43) Pub. Date: Sep. 17, 2015

(54) LIGHTING CONTROL SYSTEM AND METHOD

(71) Applicant: Shafrir ROMANO, Rishon Letzion (IL)

(72) Inventor: Shafrir ROMANO, Rishon Letzion (IL)

(21) Appl. No.: 14/658,257

(22) Filed: Mar. 16, 2015

Related U.S. Application Data
(60) Provisional application No. 61/953,949, filed on Mar. 17, 2014.

(51) Int. Cl. H05B 37/02; H05B 33/08

(52) U.S. Cl. CPC H05B 37/0272; H05B 33/0854; H05B 33/0872; H05B 33/0809

(57) ABSTRACT

A method and system for controlling a lighting arrangement is provided, wherein the lighting arrangement comprises two or more lighting drivers, the lighting drivers have a lighting parameter, and the lighting parameter has at least two lighting parameter values, each value related to a different one of the two or more lighting drivers. The method comprises the steps of: individually adjusting at least one of the at least two lighting parameter values without substantially affecting any other of the at least two lighting parameter values, and further adjusting the lighting parameter in an amount related to the at least two lighting parameter values as a whole.

### FIELD OF THE INVENTION

The present invention relates generally to lighting systems, and more particularly to methods and systems of controlled lighting.

### BACKGROUND OF THE INVENTION

Light Emitting Diodes (LED)s have become a prevailing technology in the industry of lighting. Various methods for controlling LED lighting are described in the art. Exemplary references include copending U.S. patent application Ser. No. 61/807,339, which discloses techniques that help to provide efficient LED lighting in a given space. This is achieved by controlling various LED driving parameters based on a variety of control sources. These sources include sensors of various environmental parameters such as lighting level and motion in the lighting area.

However, it would be desirable to achieve a hierarchically managed control mechanism for lighting drivers, in particular LED drivers.

### SUMMARY OF THE INVENTION

Accordingly, it is a principal object of the present invention to provide improved methods and systems of controlled driving of lighting, based on a hierarchically managed control mechanism. Thus, in accordance with an embodiment of the present invention, there is provided a method for controlling a lighting arrangement, wherein the lighting arrangement comprises two or more lighting drivers, the lighting drivers have a lighting parameter and the lighting parameter has at least two lighting parameter values, each value related to a different one of the two or more lighting drivers. The method comprises the steps of: individually adjusting at least one of the at least two lighting parameter values without substantially affecting any other of the at least two lighting parameter values, and adjusting the lighting parameter in an amount related to the at least two lighting parameter values as a whole.

In an embodiment, various lighting parameters can be adjusted such as light intensity, blinking rate and color. In other embodiments, any suitable alternative or additive lighting parameter may be applied and adjusted such as the level of authorization needed for controlling the various lighting parameters.

In an embodiment, LED lighting is used. However, in alternative embodiments other lighting technologies may be used.

In some embodiments, adjusting the lighting parameter comprises using a wireless link, which may be of various wireless types such as Bluetooth, ZigBee and wi-fi.

In accordance with an embodiment of the present invention, there is also provided a lighting system comprising a lighting arrangement and a remote controller wirelessly coupled to the lighting arrangement. The lighting arrangement comprises two or more lighting drivers having a lighting parameter, wherein the lighting parameter has at least two lighting parameter values, each related to a different one of the two or more lighting drivers. In an embodiment, the remote control is configured to individually adjust at least one of the at least two lighting parameter values without substantially affecting any other of the at least two lighting parameter values, and further to adjust the lighting parameter in an amount related to the at least two lighting parameter values as a whole.

### BRIEF DESCRIPTION OF THE DRAWINGS

The present invention will be more fully understood from the following detailed description of the embodiments thereof, taken together with the drawings in which:

FIG. 1 is a block diagram that schematically illustrates a lighting system, in accordance with an embodiment of the present invention; and

FIG. 2 is a flowchart that schematically illustrates a method of controlling a lighting system, in accordance with an embodiment of the present invention.

### DETAILED DESCRIPTION OF EMBODIMENTS

Embodiments of the present invention provide improved systems and methods that involve hierarchically managed control of lighting drivers, in particular LED drivers.

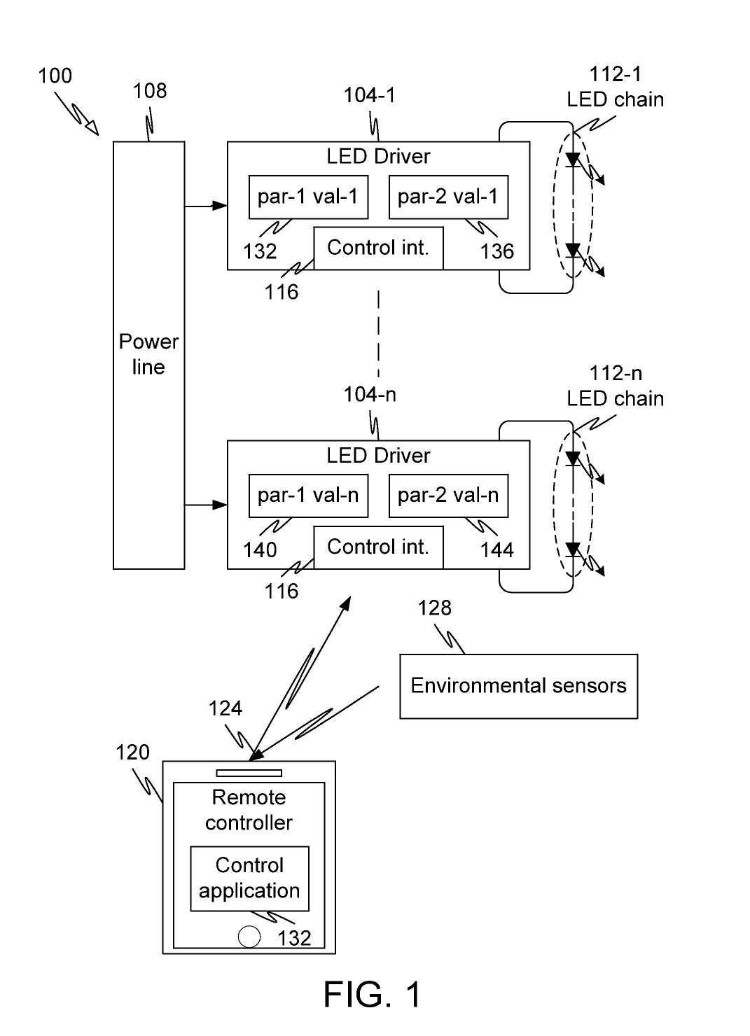

Referring to FIG. 1 there is shown a block diagram of a lighting system 100, in accordance with an embodiment of the present invention. In the figure there is shown an arrangement of n LED drivers denoted 104-1 to 104-n, fed from a power line 108, typically an AC power line. LED drivers 104-1 to 104-n drive LED chains 112-1 to 112-n correspondingly. In an embodiment, LED drivers 104 affect various lighting parameters of LED chains 112, such as lighting intensity/dimness, lighting color/dimness and lighting blinking rate and. Two lighting parameters are shown in FIG. 1 denoted par-1 and par-2. Their actual values in LED drivers 1 and n are denoted as val-1 and val-n correspondingly. These parameters, together with their actual values, are denoted in FIGS. 1 as 113, 114, 115 and 116. In other embodiments, other suitable lighting parameters may be alternatively or additively employed, such as the level of authorization needed for controlling the lighting parameters in lighting system 100.

Each LED driver 104 comprises a control interface 118, which communicates with a remote controller 120 through a wireless link 124. Block 128 denotes one or more environmental sensors, such as light and motion sensors. Sensors 128 are also linked wirelessly to remote controller 120, this linkage denoted 124 as well. Remote controller 120, wireless link 124 and sensors 128 constitute a control mechanism for controlling the overall lighting in system 100 through control interfaces 118. In an embodiment, remote controller 120 comprises a smartphone whereas wireless link 124 is Bluetooth based. In other embodiments, remote controller 120 may be realized by any suitable type of computing device, whereas wireless link 124 may be realized by any suitable technology of wireless communication, such as ZigBee and Wi-Fi.

In an embodiment, remote controller 120 runs a software application 132 running a software code for controlling lighting system 100. This application is briefly denoted “control application” 132. Control application 132 typically receives control information from various control sources. An example of such a control source is a user, not shown in FIG. 1, applying a manual command through remote controller 120. Another example is environmental sensors 128, which apply environmental data, such as light level and amount of motion in the vicinity of each LED chain 112, to control application 132, through smartphone 120. In other embodiments, other types and sources of control information may be used. Control application 132 then processes the control information, produces corresponding control commands thereof and sends the commands to relevant LED drivers 104 through wireless link 124. The addressed LED drivers then convert the received control commands to corresponding adjustments of lighting parameters par-1, par-2 etc.

The above description has focused on the specific elements of lighting system 100 that are essential for understanding certain features of the disclosed techniques. Conventional elements the system not needed for this understanding have been omitted from FIG. 1 for the sake of simplicity, but will be apparent to persons of ordinary skill in the art. The configuration shown in FIG. 1 is an example configuration, which was chosen purely for the sake of conceptual clarity. In alternative embodiments, any other suitable configurations can also be used.

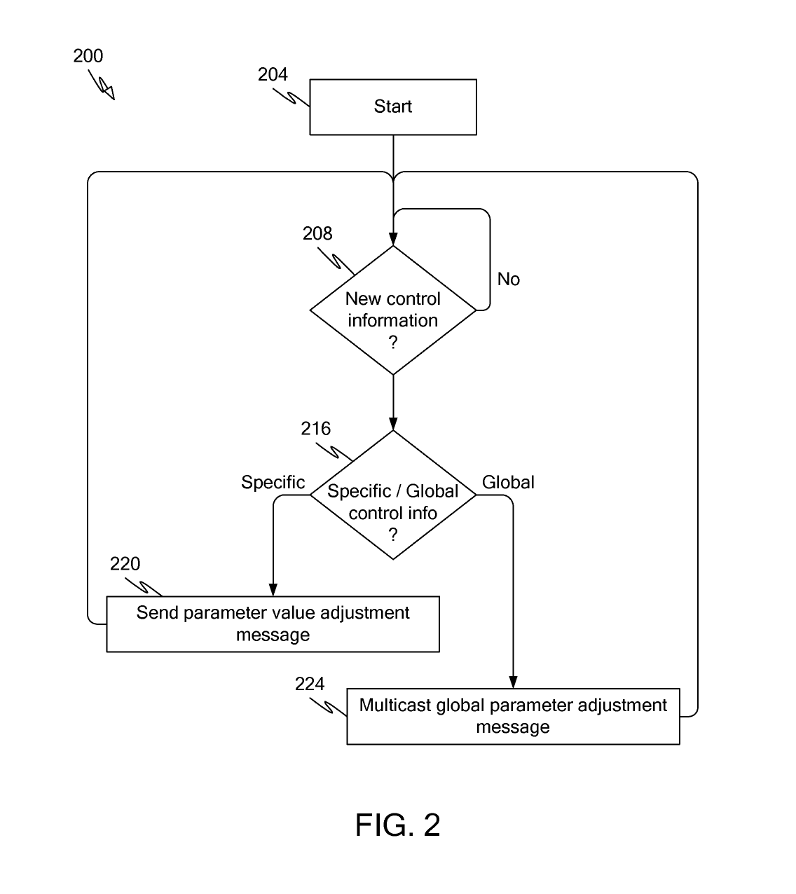

FIG. 2 shows a flowchart 200 which schematically illustrates a method for controlling lighting system 100, in accordance with an embodiment of the present invention. The method principally relates to the functionality of application 132. The method begins with a start step 204, which leads to a waiting step 208, wherein control application 132 is waiting until new control information is received as explained above. In a decision step 216, control application 132 checks the control information type, i.e. whether it is global or specific. Specific control information typically relates to a certain lighting parameter value in a specific LED driver 104. Global control information typically includes an amount of adjustment relating to a number of lighting parameter values in different LED drivers 104 as a whole.

In the case of specific control information in step 216, the method proceeds to a sending step 220, wherein control application 132 sends a parameter value adjustment message to the LED driver 104 addressed in the control information of step 208. An example specific message may cause LED driver 104-1 to set the color of LED chain 112-1 to red. Another specific message may cause setting the color of LED chain 112-n to blue. Obviously, adjusting a lighting parameter value pertaining to a specific LED chain does not affect any other LED chain.

In the case of global control information in step 216, the method proceeds to a multicasting step 224, wherein control application 132 multicasts a parameter adjustment message to either a part or all of LED drivers 104, as specified in the control information of step 208. An example of such a message may be adjusting the color of all LED chains 112-1 to 112-n to be brighter in an amount, or percentage, that is specified in the control information of step 208. The lines from steps 220 and 224 denote turning back to waiting step 208.

For a given parameter, adjusting individual parameter values, one by one, according to step 220, constitutes a lower level of a hierarchically managed control approach, whereas globally adjusting the given parameter values in different LED drivers as a whole, according to step 224, constitutes an upper level of this hierarchy. In some embodiments, the above hierarchical approach is further elaborated by realizing a hierarchical tree having more than two control levels. An example application of this elaboration to the above example may be as follows: LED chains 112-1 to 112-n are divided to several location dependent partial groups, the brightness of each is adjusted in a group specific amount, while, in the top control level, the brightness of all 112-1 to 112-n LED chains is globally adjustable as a whole.

Flowchart 200 is an example flowchart, which was chosen purely for the sake of conceptual clarity. In alternative embodiments, any other suitable flowchart can also be used for illustrating the disclosed method. Method steps that are not mandatory for understanding the disclosed techniques were omitted from FIG. 2 for the sake of simplicity.

Although the embodiments described herein mainly address lighting systems, the methods and systems exemplified by these embodiments can also be used for other controlled systems.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A method for controlling a lighting arrangement, the lighting arrangement comprising two or more lighting drivers, the lighting drivers having a lighting parameter, the lighting parameter having at least two lighting parameter values wherein each value is related to a different one of the two or more lighting drivers, the method comprising the steps of:
(a) individually adjusting at least one of the at least two lighting parameter values without substantially affecting any other of the at least two lighting parameter values; and
(b) adjusting the lighting parameter in an amount related to the at least two lighting parameter values as a whole.

2. The method of claim 1, wherein the lighting parameter comprises a lighting intensity.

3. The method of claim 1, wherein the lighting parameter comprises a lighting color.

4. The method of claim 1, wherein the lighting parameter comprises a lighting blinking rate.

5. The method of claim 1, wherein the lighting parameter comprises a level of authorization needed for controlling at least one of the one or more lighting drivers.

6. The method of claim 1, wherein the one or more lighting drivers comprise at least one light emitting diode (LED) driver.

7. The method of claim 1, wherein adjusting the lighting parameter comprises using a wireless link.

8. The method of claim 7, wherein the wireless link comprises bluetooth.

9. The method of claim 7, wherein the wireless link comprises wi-fi.

10. A lighting system comprising:
a lighting arrangement comprising two or more lighting drivers, the lighting drivers having a lighting parameter, the lighting parameter having at least two lighting parameter values wherein each value is related to a different one of the two or more lighting drivers; and
a remote controller wirelessly coupled to the two or more lighting drivers and configured:
to individually adjust at least one of the at least two lighting parameter values without substantially affecting any other of the at least two lighting parameter values, and further
to adjust the lighting parameter in an amount related to the at least two lighting parameter values as a whole.

11. The lighting system of claim 10, wherein the lighting parameter comprises a lighting intensity.

12. The lighting system of claim 10, wherein the lighting parameter comprises a lighting color.

13. The lighting system of claim 10, wherein the lighting parameter comprises a lighting blinking rate.

14. The lighting system of claim 10, wherein the lighting parameter comprises a level of authorization needed for controlling at least one of the one or more lighting drivers.

15. The lighting system of claim 10, wherein the one or more lighting drivers comprise at least one light emitting diode (LED) driver.

16. The lighting system of claim 10, wherein the remote controller is wirelessly coupled to the two or more lighting drivers using at least one of Bluetooth, ZigBee and wi-fi protocols.

17. The lighting system of claim 10, wherein the remote controller comprises a smartphone.
